(19) United States
(12) Patent Application Publication
(10) Pub. No.: US 2024/0346341 A1
(43) Pub. Date: Oct. 17, 2024

(54) METHOD AND APPARATUS FOR FUSING LAYERS OF DIFFERENT MODELS

(71) Applicant: Intel Corporation, Santa Clara, CA (US)

(72) Inventors: Guangming CHEN, Shanghai (CN); Renzhi JIANG, Shanghai (CN); Fengyi SUN, Shanghai (CN); Zhengxu HUANG, Shanghai (CN); Jingxuan DONG, Shanghai (CN)

(73) Assignee: Intel Corporation, Santa Clara, CA (US)

(21) Appl. No.: 18/575,139

(22) PCT Filed: Nov. 30, 2021
(86) PCT No.: PCT/CN2021/134286

§ 371 Date: Dec. 28, 2023

(51) Int. Cl. G06N 5/022

(52) U.S. Cl. CPC G06N 5/022

(57) ABSTRACT

The disclosure relates to method and apparatus for fusing layers of different models. The method for fusing layers of different models comprises: searching layers from different models and determining whether to perform layer fusing; fusing instructions in the layers from different models into a fused instruction in response to determining to perform layer fusing; combining input data for the instructions in the layers from different models into a combined input data; allocating a continuous storage area in a memory for the combined input data; loading the combined input data for the fused instruction from the continuous storage area in the memory to perform the fused instruction; and storing output data obtained after performing the fused instruction into a continuous storage area in the memory.

### TECHNICAL FIELD

Embodiments described herein generally relate to the field of artificial intelligence (AI), and more particularly relate to method and apparatus of fusing layers of different models.

### BACKGROUND

AI, as a new technology, is used in more and more scenarios these years. To deploy these AI models, lots of computation resources are required. To save the cost, more and more enterprises deploy their AI models on the Cloud or Edge Servers, the density of AI workloads per server is a very important factor to determine whether the AI model can be deployed for commercial usage.

### BRIEF DESCRIPTION OF THE DRAWINGS

The various advantages of the embodiments will become apparent to one skilled in the art by reading the following specification and appended claims, and by referencing the following drawings, in which:

FIG. 1 is a diagram showing the utilization of instruction in different layers in a AI model, according to some embodiments of the present disclosure;

FIG. 2 is a diagram showing an overview of typical inference use case in a server to which a layer fusing method can be applied, according to some embodiments of the present disclosure;

FIG. 3a is a diagram showing instruction utilization before layer fusing optimization, according to some embodiments of the present disclosure;

FIG. 3b is a diagram showing instruction utilization after layer fusing optimization, according to some embodiments of the present disclosure;

FIG. 4 is a diagram showing an overview of instruction utilization after layer fusing optimization by using a layer fusing apparatus, according to some embodiments of the present disclosure;

FIG. 5 is a diagram showing a degree of saturation of OIhw4i16O4i implementation that is used by a convolution layer in a quantized model, according to some embodiments of the present disclosure;

FIG. 6 is a diagram showing impact factor for two layers from different models, according to some embodiments of the present disclosure;

FIG. 7 is a diagram showing the operation of a memory manager, according to some embodiments of the present disclosure;

FIG. 8 is a diagram showing arithmetic intensity in the case of compute bounding, according to some embodiments of the present disclosure;

FIG. 9 is a diagram showing arithmetic intensity in the case of memory bounding, according to some embodiments of the present disclosure;

FIG. 10 is a diagram showing memory layout and register utilization before and after layer fusing optimization, according to some embodiments of the present disclosure;

FIG. 11 is a diagram showing improvement results from simplified implementation using the layer fusing apparatus, according to some embodiments of the present disclosure;

FIG. 12 is a flowchart showing a method for fusing layers of different models, according to some embodiments of the present disclosure; and

FIG. 13 shows a block diagram of an example computing system that can implement a method for fusing layers of different model according to some embodiments of the present disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

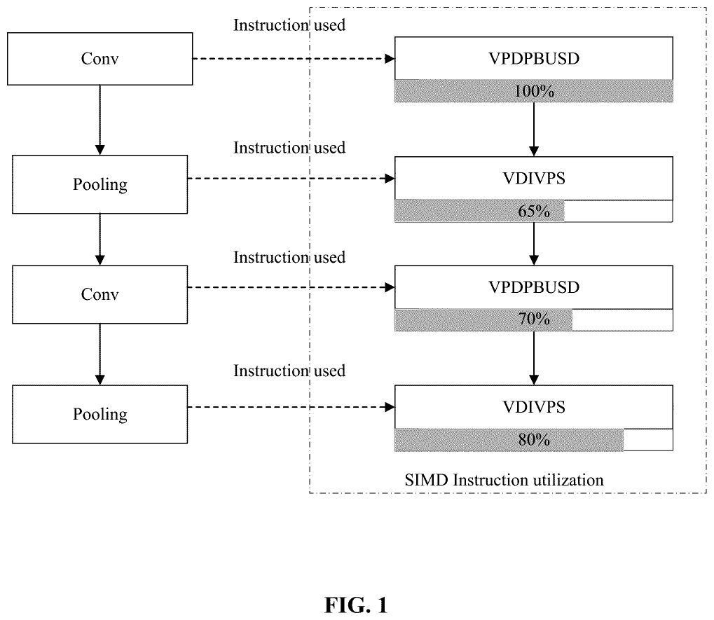

As we known, AI model consists lots of layers, such as convolution layers, activations layers and pooling layers, etc. Most layers can be processed with advanced instructions for AI workload on CPUs (such as Intel CPUs) to boost the performance, such as Vector Neural Network Instruction (VNNI), Tile matrix multiply unit (TMUL) and Advanced Matrix Extension (AMX). However, as shown in FIG. 1, it's very common that some layers of one model cannot fully utilize a Single Instruction Multiple Data (SIMD) instruction, because the data layout of such layer cannot fully fill the register at once. This will lead to the uncompetitive AI workload density performance. Thus, it needs to find a method to improve the utilization of CPU computing capability to boost the density of AI workloads on various platforms.

Currently, AI inference optimization is model independent. It means that graph optimization and instruction optimization are layer-level for an AI model.

Layer-level optimization for a model does not consider the optimization possibility for multiple models. Therefore, it may not achieve the optimal instruction (for example, SIMD instruction) utilization on a CPU server (such as an Intel CPU server). Sometimes layer-level optimization can only be applied to a specific model, and some layers may require less computation resource then there's not much space for optimization. Furthermore, layer-level optimization may introduce reorder operation overhead.

To solve the instruction utilization issue on CPUs when running multiple models, it proposes a novel method to fuse layers of different models. The proposed method will collect layers with low instruction utilization from different models and fuse these layers with a graph optimizer. A cost function will be used to decide if it has benefit to do layer fusion. With the layer fusion from different models, the overall instruction utilization can be improved.

An aspect of the present disclosure provides a layer fusing apparatus, comprising interface circuitry; processor circuitry coupled to the interface circuitry and configured to; search layers from different models and determine whether to perform layer fusing; fuse instructions in the layers from different models into a fused instruction in response to determining to perform layer fusing; combine input data for the instructions in the layers from different models into a combined input data; allocate a continuous storage area in a memory for the combined input data; load the combined input data for the fused instruction from the continuous storage area in the memory to perform the fused instruction; and store output data obtained after performing the fused instruction into a continuous storage area in the memory.

An aspect of the present disclosure provides a method for fusing layers of different models, comprising: searching layers from different models and determining whether to perform layer fusing; fusing instructions in the layers from different models into a fused instruction in response to determining to perform layer fusing; combining input data for the instructions in the layers from different models into a combined input data; allocating a continuous storage area in a memory for the combined input data; loading the combined input data for the fused instruction from the continuous storage area in the memory to perform the fused instruction; and storing output data obtained after performing the fused instruction into a continuous storage area in the memory.

An aspect of the present disclosure provides a computer-readable storage medium with program instructions stored thereon which, when executed by a processor, cause the processor to: search layers from different models and determine whether to perform layer fusing; fuse instructions in the layers from different models into a fused instruction in response to determining to perform layer fusing; combine input data for the instructions in the layers from different models into a combined input data; allocate a continuous storage area in a memory for the combined input data; load the combined input data for the fused instruction from the continuous storage area in the memory to perform the fused instruction; and store output data obtained after performing the fused instruction into a continuous storage area in the memory.

With the proposed multi-model layer fusion method, CPU computation resource utilization can be maximized, which can help customer boost their AI workload density and then reduce TCO on CPUs. It shall be understood that the solution of fusing layers from different models can be used for any model and is easy to be deployed on customer's production servers. The multi-model layer fusion method can also be copyable for different hardware platforms.

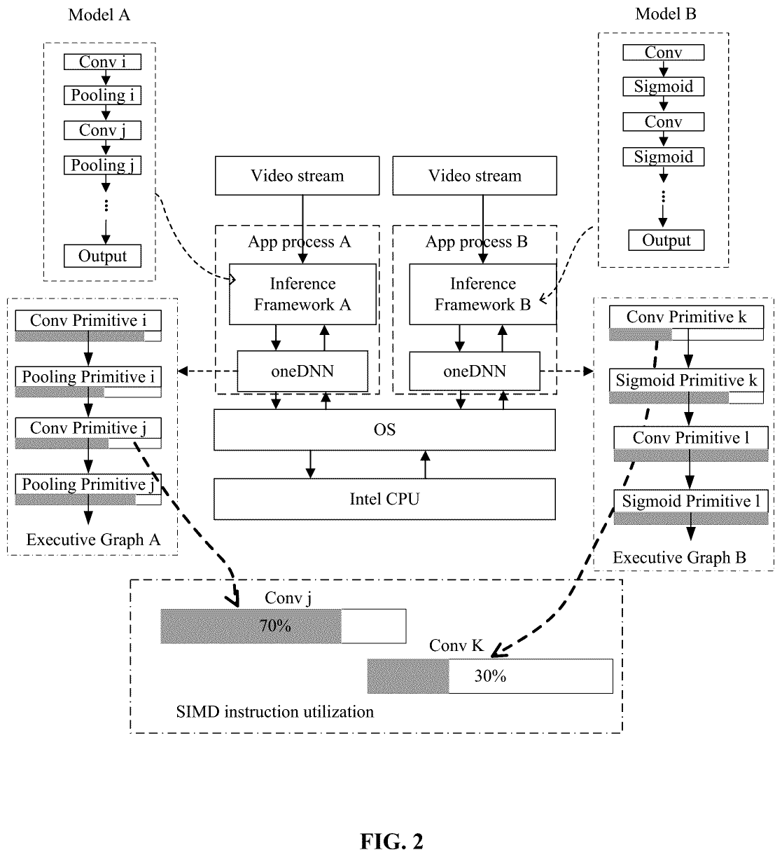

A typical server runs different inference tasks for multiple user applications and different applications have different models. FIG. 2 shows a using scenario in which the layer fusing method according to the present disclosure can be applied. FIG. 2 shows two models, i.e. model A and model B, each have multiple layers. These applications may use, for example, intel deep learning boost instruction sets, such as VNNI, to accelerate the inference on Intel server. It shall be understood that the instruction sets are not limited to intel deep learning boost instruction sets and any other instruction sets can also be applied according to the present disclosure.

Intel deep learning boost instructions, such as VPDPBUSD, are used to accelerate the primitives in oneAPI Deep Neural Network Library (oneDNN). However, the registers could not be fully utilized in some cases. It can be seen from FIG. 2 that the instruction utilization in convolution primitive j in model A is 70% and the instruction utilization in convolution primitive k in model B is 30%, which indicates that the instruction utilization is low.

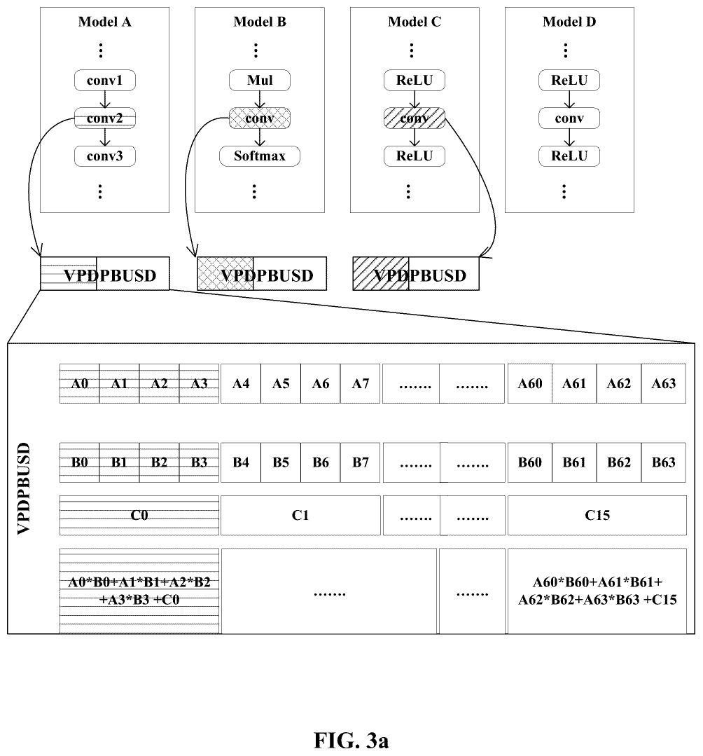

Generally, for multiple models each having multiple layers, a storage area in a memory will be independently allocated for instruction to be performed in each layer in each model. However, in this case, the ZMM register size is often larger than convolution kernel, which results that VPDPBUSD instruction could not be fully utilized, as shown in FIG. 3a.

The essential idea of the present disclosure is to fuse layers from different models, then the same instructions (for example, the same SIMD instructions) from different models can be fused to fully utilize the registers. In particular, the instructions in the layers from different models are fused into a fused instruction, input data for the instructions in the layers from different models are combined into a combined input data, and a continuous storage area in a memory is allocated for the combined input data. After doing so, the combined input data for the fused instruction are loaded from the continuous storage area in the memory to perform the fused instruction; and the output data obtained after performing the fused instruction are stored into a continuous storage area in the memory. It can be seen that after fusing, the total memory size for computation won't change, and the number of total instructions will be reduced, which will help improve the overall performance. As shown in FIG. 3b, after the instruction fusion, 3 convolution layers in 3 models will share the same one instruction and register.

According to the present disclosure, it proposes a layer fusing apparatus to perform layer fusing by fusing instructions from layers of different models. The layer fusing apparatus can be implemented within a controller, a microcontroller or a processor. In one embodiment, the layer fusing apparatus implements a deep learning (DL) accelerator service that can run as a daemon process to handle all the inference requests from user application processes. In order to implement layer fusing, the layer fusing apparatus according to the present disclosure is configured to: search layers from different models and determine whether instructions in the layers from different models shall be fused; fuse the instructions in the layers from different models into a fused instruction in response to determining that the instructions in the layers from different models shall be fused; combine input data for the instructions in the layers from different models into a combined input data; allocate a continuous storage area in a memory for the combined input data; load the combined input data for the fused instruction from the continuous storage area in the memory to perform the fused instruction; and store output data obtained after performing the fused instruction into a continuous storage area in the memory.

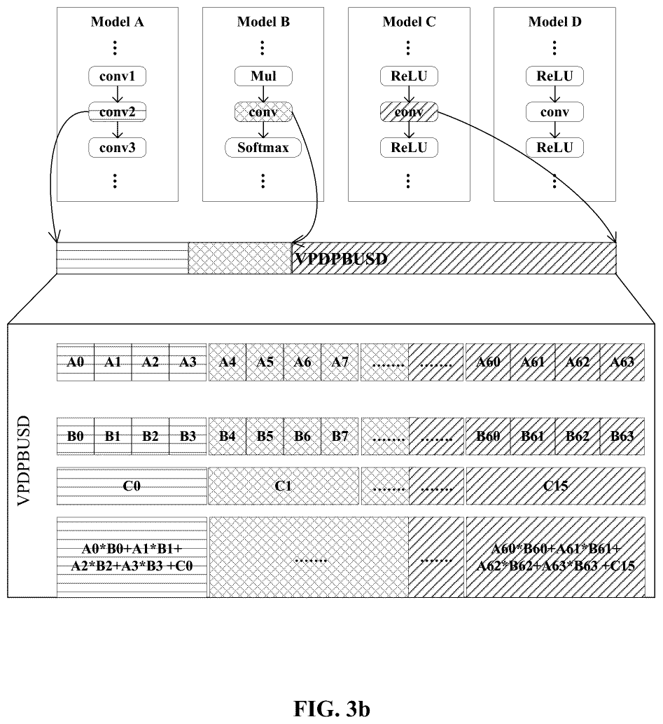

In some embodiments, the layer fusing apparatus can be configured as containing two components: a graph optimizer and a memory manager, as shown in FIG. 4. However, it shall be noted that although the layer fusing apparatus is shown having a graph optimizer and a memory manage, it is only for illustrative purposes to show the principles of the present disclosure more clearly and the present disclosure is not limited to this specific configuration. In some embodiments, the functions of both of the graph optimizer and the memory manage are implemented by the layer fusing apparatus alone. In some embodiments, the layer fusing apparatus can also contain other components according to practical requirements.

The general design of the graph optimizer and the memory manager will be described in the following.

### Graph Optimizer

According to some embodiments, the graph optimizer could be an offline tool to search which layer can be fused in each of different models. Further, the graph optimizer can be configured to have a cost function to determine whether it will benefit from fusing or not. According to some embodiments, it proposes to use a degree of saturation σ of layer as a first fusing metric to determine whether to perform layer fusing by considering instruction (for example, SIMD instruction) utilization in each layer which characterizes a ratio of the portion of a register actually utilized by the SIMD instruction to the whole register allocated for the SIMD instruction. In some embodiments, the degree of saturation can be used to indicate the efficiency of primitive in oneDNN. The degree of saturation is related to the platform and implementation of layer. For example, the convolution layer in a quantized model uses OIhw4i16O4i implementation for parallelization in oneDNN that can take advantage of AVX512/VNNI instruction sets.

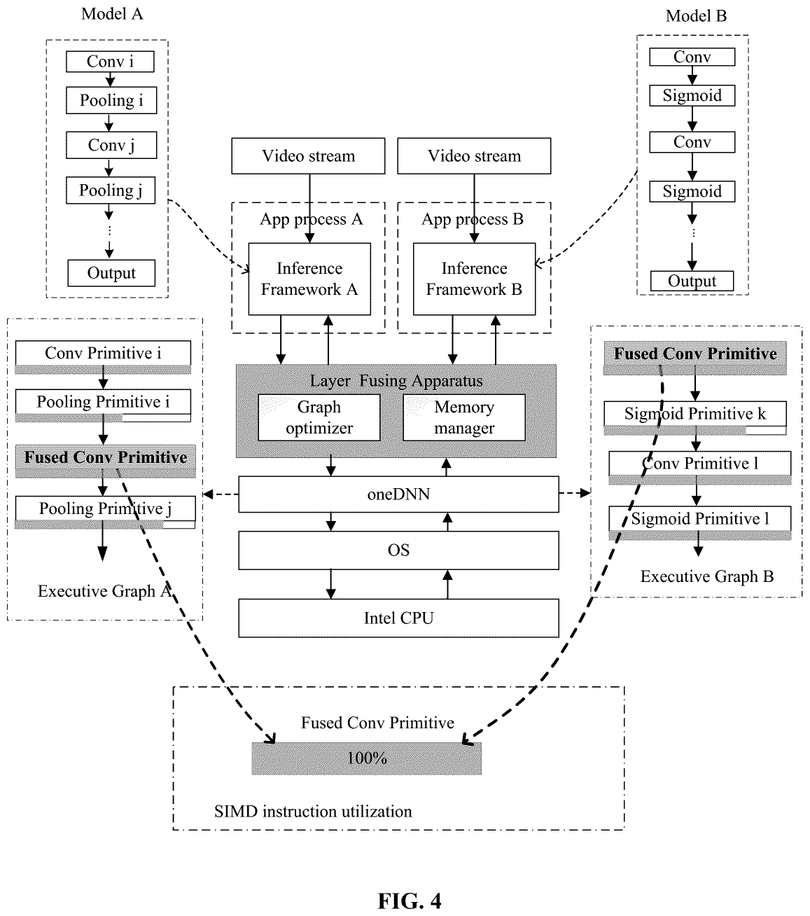

FIG. 5 is a diagram showing the degree of saturation of OIhw4i16O4i implementation that is used by a convolution layer in a quantized model, wherein the points in the bottom that are surrounded by dotted lines are valid data. As shown in FIG. 5, in this case, the convolution input shape is 1*1*218*12 and the kernel shape is 34*1*19*12, only 25% data of ZMM register is valid due to the kernel's input channel=1. Therefore, the degree of saturation of this case is 25%, which indicates the efficiency of this primitive is low. According to some embodiments, a predetermined threshold for the degree of saturation can be set in configuration files for the graph optimizer and the graph optimizer is configured to determine whether to perform layer fusing based on the comparison of the degree of saturation in a layer with the predetermined threshold for the degree of saturation. In some embodiments, the predetermined threshold for the degree of saturation can be set to 50% and the graph optimizer is configured to determine to perform layer fusing if the degree of saturation of instruction in this layer is less than the predetermined threshold for the degree of saturation. According to some embodiments, the layers with the degree of saturation of instruction higher than the predetermined threshold for the degree of saturation can be filtered out and are not fused. It shall be understood that the predetermined threshold for the degree of saturation can be set according to practical requirements.

According to some embodiments, it further proposes to use an impact factor φ calculated for layers from different models as a second fusing metric to determine whether to perform layer fusing. The impact factor φ indicates whether performing layer fusing will add sync points overhead that would cause performance hits. Specifically, the graph optimizer is configured to determine whether adding sync point cost too much when fusing layers based on the impact factor φ.

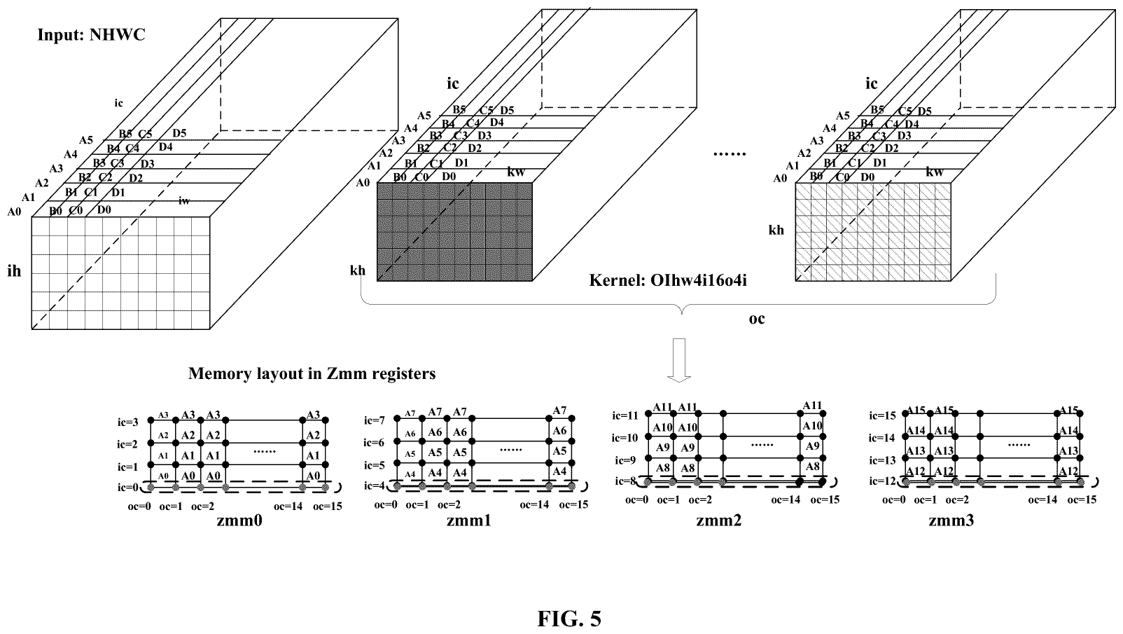

According to some embodiments, the impact factor φ_{i,j} for fusing i-th layer in m-th model with j-th layer in n-th model can be calculated as below, which is also shown in FIG. 6:

$${φ}_{i , j} = \frac{min ( {\sum }_{a = 1}^{i} {t}_{{m}_{a}} , {\sum }_{b = 1}^{j} {t}_{{n}_{b}} )}{max ( {\sum }_{a = 1}^{i} {t}_{{m}_{a}} , {\sum }_{b = 1}^{j} {t}_{{n}_{b}} )}$$

wherein Σₐ₌₁ⁱ tₘ_{ₐ} represents cumulative layer execution time for layers from the first layer to i-th layer in m-th model, wherein i is not less than 1 and not greater than the number of the layers of m-th model; and Σ_{b=1}^{j} tₙ_{_{b}} represents cumulative layer execution time for layers from the first layer to j-th layer in n-th model, wherein j is not less than 1 and not greater than the number of the layers of n-th model.

According to some embodiments, a predetermined threshold for the impact factor φ_{i,j} can be set in configuration files for the graph optimizer and the graph optimizer is configured to determine whether to perform layer fusing based on the comparison of the calculated impact factor for layers with the predetermined threshold for the impact factor. It shall be understood that the predetermined threshold for the impact factor can be set according to practical requirements. For example, during graph optimization, it can calculate the impact factor φ_{i,j} for fusing the first layer in m-th model with the last layer in n-th model. Specifically, let i=1, j=c, wherein c is the number of the layers of n-th model, then the impact factor φ_{i,j} for fusing the first layer in m-th model with the last layer in n-th model would be:

$${φ}_{1 , c} = \frac{{t}_{{m}_{1}}}{{\sum }_{b = 1}^{c} {t}_{{n}_{b}}} ,$$

which is much less than 1, the graph optimizer will not fuse these two layers. In some embodiments, the graph optimizer is configured to fuse i-th layer in m-th model with j-th layer in n-th model only if φ_{i,j}≈1, which means no one is blocking the other between these two layers.

It shall be understood that although the present disclosure gives the above equation for calculating the impact factor φ_{i,j} for two layers from different models, similar equations can be used to calculate the impact factor for three or more layers from different models.

Although the degree of saturation and impact factor can be used as fusing metrics to determine whether to perform layer fusing, it is not enough in some cases. According to some embodiments, it further proposes to use a score calculated for layers from different models as a third fusing metric to determine whether to perform layer fusing by comprehensively considering the degree of saturation, the impact factor and other factors. The equation to calculate score is shown as follows:

$${Score}_{{m}_{i} {n}_{j}} = {w}_{m} * {w}_{n} * {w}_{{m}_{i}} * {w}_{{n}_{j}} * {φ}_{i , j} * ( 1 - {σ}_{{m}_{i}} ) * ( 1 - {σ}_{{n}_{j}} )$$

$${w}_{m} = \frac{{\sum }_{a = 1}^{n umber of layers of m - th model} {t}_{{m}_{a}}}{{\sum }_{k = 1}^{n u mber of models} {\sum }_{i = 1}^{n umber of layers of k - th model} {t}_{{k}_{i}}}$$

$${w}_{n} = \frac{{\sum }_{b = 1}^{number of layers of n - th model} {t}_{{n}_{b}}}{{\sum }_{k = 1}^{n u mber of models} {\sum }_{i = 1}^{number of layers of k - th model} {t}_{{k}_{i}}}$$

$${w}_{{m}_{i}} = \frac{{t}_{{m}_{i}}}{{\sum }_{a = 1}^{number of layers of m - th model} {t}_{{m}_{a}}}$$

$${w}_{{n}_{j}} = \frac{{t}_{{n}_{j}}}{{\sum }_{b = 1}^{number of layers of n - th model} {t}_{{n}_{b}}}$$

wherein σₘ_{ᵢ} is the degree of saturation of i-th layer in m-th model and σₙ_{ⱼ} is the degree of saturation of j-th layer in n-th model, which can be calculated as described above; wₘ is a weight of m-th model's execution time in total models' execution time; wₙ is a weight of n-th model's execution time in total models' execution time; wₘ_{ᵢ} is a weight of i-th layer's execution time in m-th model's execution time; wₙ_{ⱼ} is a weight of j-th layer's execution time in n-th model's execution time; tₘ_{ᵢ} is i-th layer's execution time in m-th model, wherein i is not less than 1 and not greater than the number of the layers of m-th model; tₙ_{ⱼ} is j-th layer's execution time in n-th model, wherein j is not less than 1 and not greater than the number of the layers of the n-th model; and φ_{i,j} is the impact factor for fusing i-th layer in m-th model with j-th layer in n-th model, which can be calculated as described above. From on the above equations for calculating the score, it can be seen that since Scoreₘ_{ᵢ}ₙ_{ⱼ} is calculated by considering more factors, it can be used as a better fusing metric for i-th layer in m-th model and j-th layer in n-th model. The higher score means that the more benefit it may get after fusing the layers.

In some embodiments, a predetermined threshold for the score can be set in configuration files for the graph optimizer and the graph optimizer is configured to determine whether to perform layer fusing based on the comparison of the calculated score for layers with the predetermined threshold for the score. In some embodiments, the graph optimizer is configured to determine to perform layer fusing if the calculated score for layers is higher than the predetermined threshold for the score.

It shall be understood that although the present disclosure describes using the above equations to calculate the score, it is just one embodiment of the present disclosure and other appropriate methods for calculating the score can be used according to practical requirements.

When it is determined that the layer fusing shall be performed, the instructions in the layers from different models are fused into a fused instruction and input data for the instructions in the layers from different models are combined into a combined input data.

### Memory Manager

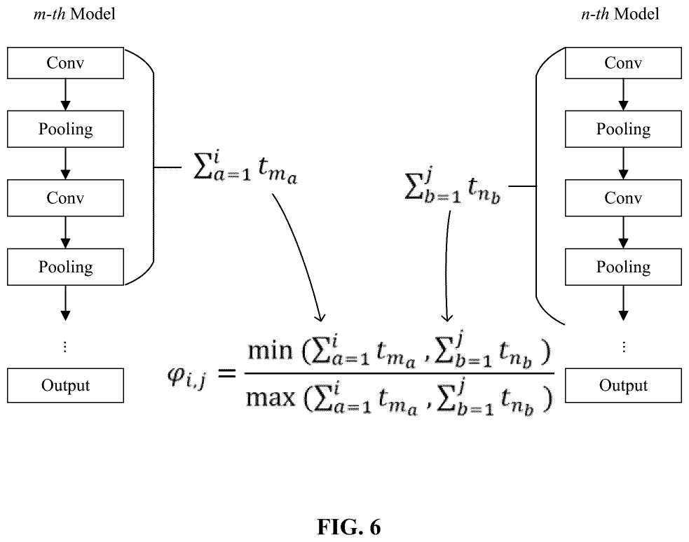

After the instructions in the layers from different models are fused into a fused instruction and input data for the instructions in the layers from different models are combined into a combined input data, the memory manager arranges memory allocation for each layer, especially for the fused layers. Specifically, the memory manager is configured to ensure that the fused instructions are fed with or written into a continuous storage area in a memory from multiple processes. To fulfill this requirement, the memory manager allocates a continuous buffer pool as a shared storage area in the memory for the fused instructions and provides an interface for the processes to load combined input data for the fused instruction and storing the output data obtained after performing operation of the fused instruction. As shown in FIG. 7, the memory manager allocates combined input data for a VPDPBUSD instruction from a fused convolution primitive, and data load instructions can just use the virtual address from memory manager process. The continuous memory buffer pool can also help reduce data cache miss.

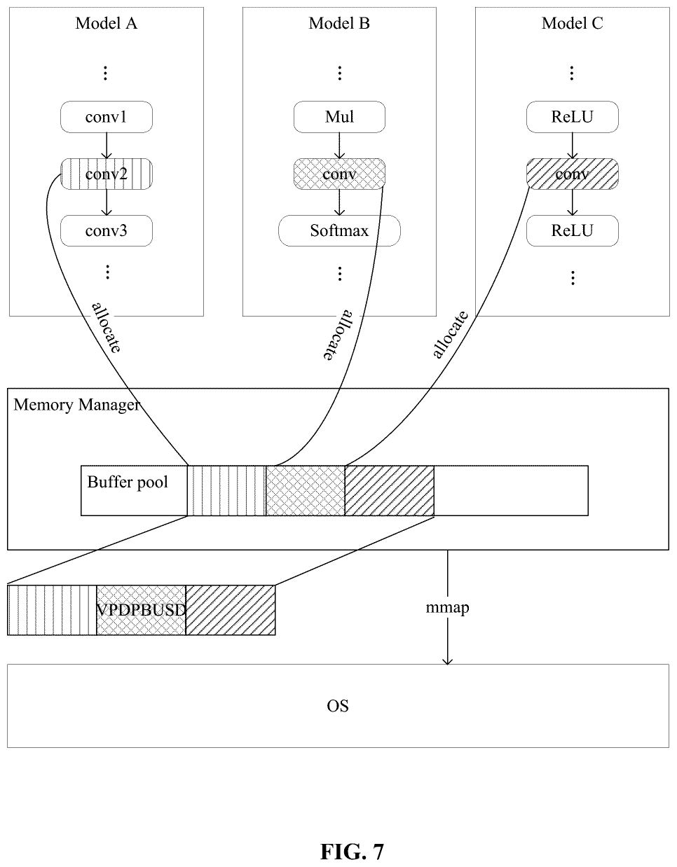

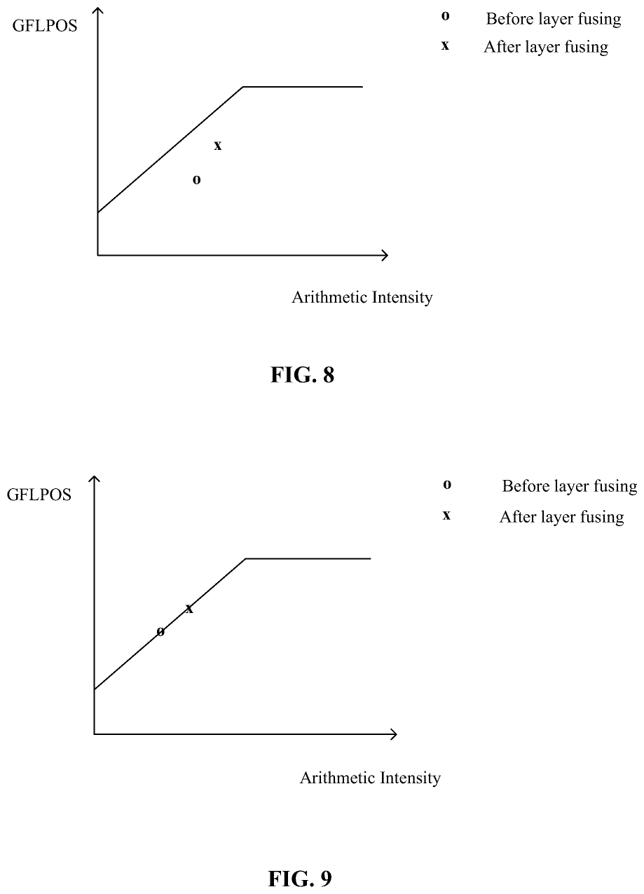

It shall be understood that the whole memory footprint would be kept the same with the layer fusing since the memory size allocated by memory manager is the same as when it was allocated by separated user process before fusing (the difference is memory manager allocates continuous physical memory for layers instructions fusing). Based on this, considering the arithmetic intensity in following cases:
Case 1: when it is compute bounding, layer fusing increases compute efficiency, the arithmetic intensity can be improved, as shown in FIG. 8.
Case 2: when it is memory bounding, total instructions should be reduced after layer fusing, the overall performance will be improved, as shown in FIG. 9.

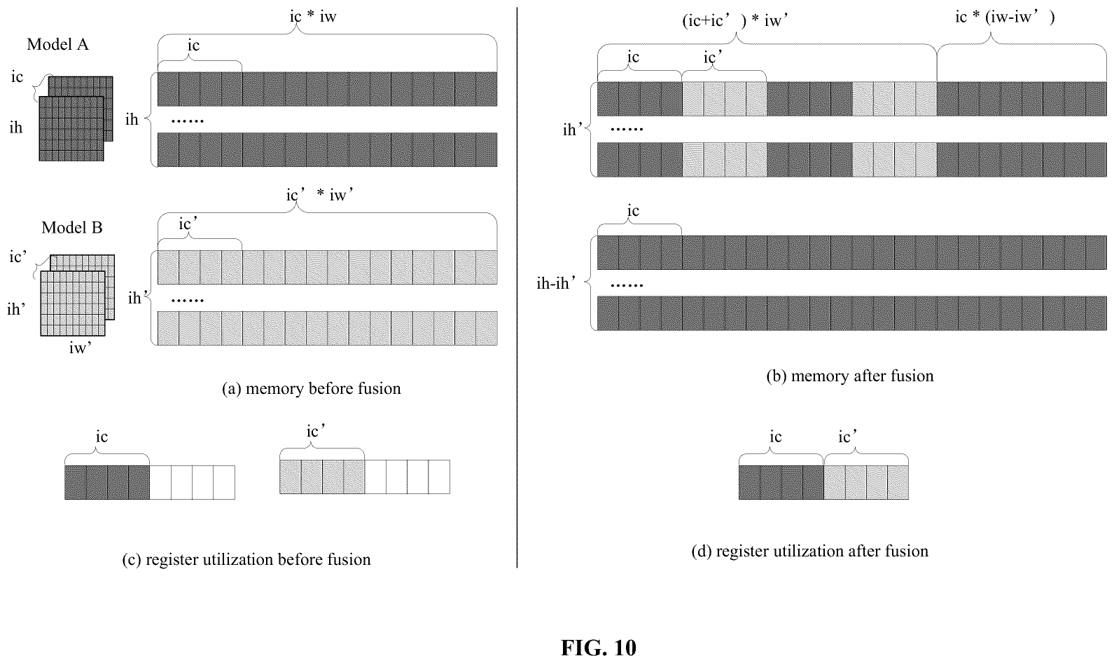

Specifically, there is no additional memory or other resource bottlenecks generated during the process of layer fusing optimization. For simplification purpose, we assume the batch size of model A and model B equal to 1 and model is quantized. As shown in FIG. 10 (a) and FIG. 10 (b), before layer fusing optimization, layer X of model A needs ih×iw×ic memory size. Layer Y of model B needs ih′×iw′×ic′ memory size. After fusing of layer X and layer Y, the total memory used is the same. To reduce the data load and store cache miss, the input data is organized together in a contiguous physical memory after fusing the layers. As shown in FIG. 10 (c) and FIG. 10 (d), after the fusion, the register utilization will be improved.

As the graph optimizer is offline, it won't introduce any memory overhead at runtime.

### Simulation Data

A simplified implementation has been conducted to optimize some models from customer running with Open Visual Inference & Neural Network Optimization (OpenVINO). The model has several convolution layers with special kernel size. For example, some convolutions have only one input channel, which means the utilization of SIMD instruction has a large development to improve. The optimization progress is shown as following steps:
Step 1: combine two models in graph loading phase to a combined model.
Step 2: analyze the combined model in the graph optimizer. It can find that the degree of saturation in convolution layers is about 25%.
Step 3: the graph optimizer fuses convolutions in the combined model. Several convolutions will use the same instruction and share the same register. After the fusion, the utilization of SIDM instruction will has a large improvement.
Step 4: infer the execute graph after the graph optimization.

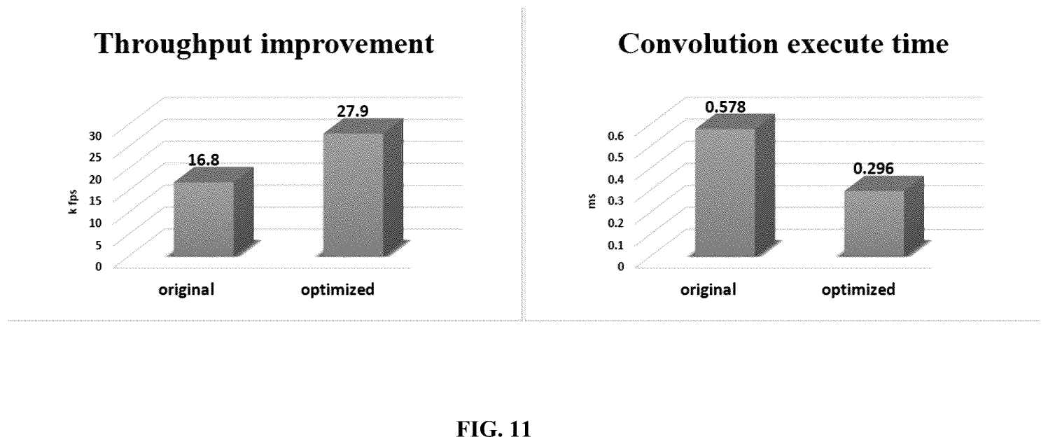

The result shows that the throughput of AI workloads per server has about 66% improvement. As shown in FIG. 11. The convolution's execute time has about 50% improvement.

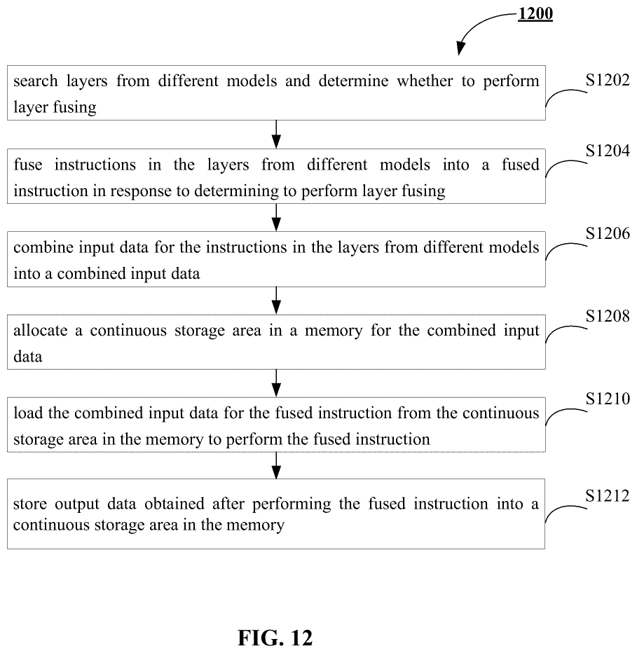

FIG. 12 is a flowchart showing a method for fusing layers of different models according to some embodiments of the present disclosure. As shown in FIG. 12, the method 1200 comprises: S1202, searching layers from different models and determining whether to perform layer fusing; S1204, fusing instructions in the layers from different models into a fused instruction in response to determining to perform layer fusing; S1206, combining input data for the instructions in the layers from different models into a combined input data; S1208, allocating a continuous storage area in a memory for the combined input data; S1210, loading the combined input data for the fused instruction from the continuous storage area in the memory to perform the fused instruction; and S1212, storing output data obtained after performing the fused instruction into a continuous storage area in the memory.

In some embodiments, the method further comprises determining whether to perform layer fusing based on a first fusing metric.

In some embodiments, the first fusing metric is a degree of saturation indicating instruction utilization in a layer that characterizes a ratio of the portion of a register actually utilized by the instruction to the whole register allocated for the instruction.

In some embodiments, the method further comprises determining whether to perform layer fusing based on the comparison of the degree of saturation in a layer with a predetermined threshold for the degree of saturation.

In some embodiments, wherein the method further comprises filtering out a layer if the degree of saturation in the layer is higher than the predetermined threshold for the degree of saturation.

In some embodiments, the method further comprises determining whether to perform layer fusing based on a second fusing metric.

In some embodiments, the second fusing metric is an impact factor calculated for layers from different models, the impact factor indicating whether performing layer fusing will add sync points overhead that would cause performance hits.

In some embodiments, the impact factor is calculated by the following equation:

$${φ}_{i , j} = \frac{min ( {\sum }_{a = 1}^{i} {t}_{{m}_{a}} , {\sum }_{b = 1}^{j} {t}_{{n}_{b}} )}{max ( {\sum }_{a = 1}^{i} {t}_{{m}_{a}} , {\sum }_{b = 1}^{j} {t}_{{n}_{b}} )}$$

wherein φ_{i,j} is the impact factor, Σₐ₌₁ⁱ tₘ_{ₐ} represents cumulative layer execution time for layers from the first layer to i-th layer in m-th model, wherein i is not less than 1 and not greater than the number of the layers of m-th model; and Σ_{b=1}^{j} tₙ_{_{b}} represents cumulative layer execution time for layers from the first layer to j-th layer in n-th model, wherein j is not less than 1 and not greater than the number of the layers of n-th model.

In some embodiments, the method further comprises determining whether to perform layer fusing based on the comparison of the calculated impact factor for layers with a predetermined threshold for the impact factor.

In some embodiments, the method further comprises determining to perform layer fusing if the calculated impact factor for layers is higher than the predetermined threshold for the impact factor.

In some embodiments, the method further comprises determining whether to perform layer fusing based on a third fusing metric.

In some embodiments, the third metric is a score calculated for layers from different models, the score indicating the benefit it may get after performing layer fusing.

In some embodiments, the score is calculated by the following equation:

$${Score}_{{m}_{i} {n}_{j}} = {w}_{m} * {w}_{n} * {w}_{{m}_{i}} * {w}_{{n}_{j}} * {φ}_{i , j} * ( 1 - {σ}_{{m}_{i}} ) * ( 1 - {σ}_{{n}_{j}} )$$

$${w}_{m} = \frac{{\sum }_{a = 1}^{number of layers of m - th model} {t}_{{m}_{a}}}{{\sum }_{k = 1}^{n u mber of models} {\sum }_{i = 1}^{number of layers of k - th model} {t}_{{k}_{i}}}$$

$${w}_{n} = \frac{{\sum }_{b = 1}^{number of layers of n - th model} {r}_{{n}_{b}}}{{\sum }_{k = 1}^{n u mber of models} {\sum }_{i = 1}^{n umber of layers of k - th model} {t}_{{k}_{i}}}$$

$${w}_{{m}_{i}} = \frac{{t}_{{m}_{i}}}{{\sum }_{a = 1}^{number of layers of m - th model} {t}_{{m}_{a}}}$$

$${w}_{{n}_{j}} = \frac{{t}_{{n}_{j}}}{{\sum }_{b = 1}^{number of layers of n - th model} {t}_{{n}_{b}}}$$

wherein σₘ_{ᵢ} is the degree of saturation of i-th layer in m-th model; σₙ_{ⱼ} is the degree of saturation of j-th layer in n-th model; wₘ is a weight of m-th model's execution time in total models' execution time; wₙ is a weight of n-th model's execution time in total models' execution time; wₘ_{ᵢ} is a weight of i-th layer's execution time in m-th model's execution time; wₙ, is a weight of j-th layer's execution time in n-th model's execution time; tₘ_{ᵢ} is i-th layer's execution time in m-th model, wherein i is not less than 1 and not greater than the number of the layers of m-th model; tₙ_{ⱼ} is j-th layer's execution time in n-th model, wherein j is not less than 1 and not greater than the number of the layers of the n-th model; and φ_{i,j} is the impact factor for fusing i-th layer in m-th model with j-th layer in n-th model.

In some embodiments, the method further comprises determining whether to perform layer fusing based on the comparison of the calculated score for layers with a predetermined threshold for the score.

In some embodiments, the method further comprises determining to perform layer fusing if the calculated score for layers is higher than the predetermined threshold for the score.

In some embodiments, searching layers from different models can be performed by an offline operation.

In some embodiments, the method further comprises allocating a continuous buffer pool as a shared storage area in the memory for the fused instructions.

In some embodiments, the method further comprises providing an interface for loading the combined input data for the fused instruction and storing the output data obtained after performing operation of the fused instruction.

In some embodiments, the instructions comprise Single Instruction Multiple Data (SIMD) instructions that includes Vector Neural Network Instruction (VNNI), Tile matrix multiply unit (TMUL) and Advanced Matrix Extension (AMX).

In some embodiments, the models are AI models.

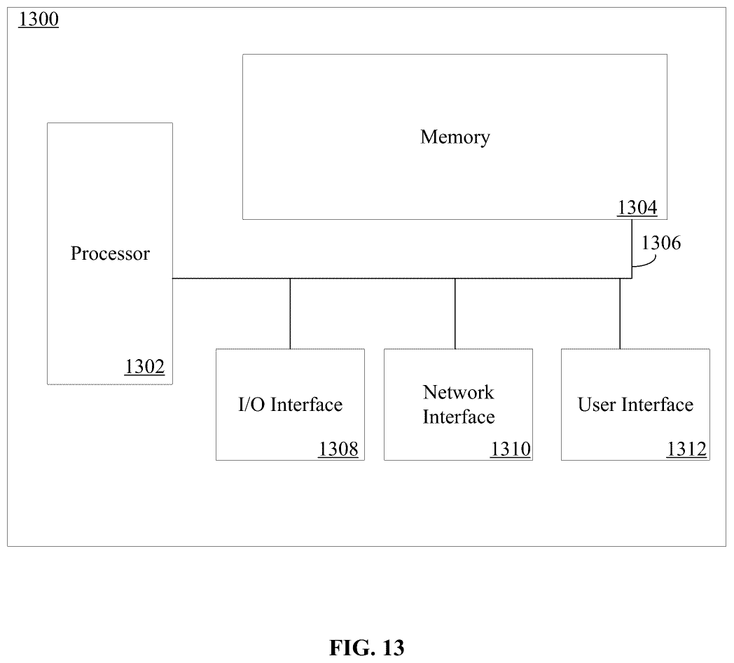

FIG. 13 illustrates an exemplary computing system 1300 that can implement the method for fusing layers of different models according to some embodiments of the present disclosure. The computing system 1300 may include a processor 1302 in communication with a memory 1304. The memory 1304 can include any device, combination of devices, circuitry, and the like that is capable of storing, accessing, organizing and/or retrieving data. Non-limiting examples include SANs (Storage Area Network), cloud storage networks, volatile or non-volatile RAM, phase change memory, optical media, hard-drive type media, and the like, including combinations thereof.

The computing system 1300 may additionally include a local communication interface 1306 for connectivity between the various components of the system. For example, the local communication interface 1306 may be a local data bus and/or any related address or control busses as may be desired.

The computing system or device 1300 may also include an I/O (input/output) interface 1308 for controlling the I/O functions of the system, as well as for I/O connectivity to devices outside of the computing system 1300. A network interface 1310 may also be included for network connectivity. The network interface 1310 may control network communications both within the system and outside of the system. The network interface may include a wired interface, a wireless interface, a Bluetooth interface, optical interface, and the like, including appropriate combinations thereof. Furthermore, the computing system 1300 may additionally include a user interface 1312 as well as various other components that would be beneficial for such a system.

The processor 1302 may be a single processor or multiple processors, and the memory 1304 may be a single memory or multiple memories. The local communication interface 1306 may be used as a pathway to facilitate communication between any of a single processor, multiple processors, a single memory, multiple memories, the various interfaces, and the like, in any useful combination.

Some non-limiting examples are provided below. Each of the examples stands as a separate embodiment itself.
Example 1 includes a layer fusing apparatus, comprising interface circuitry; processor circuitry coupled to the interface circuitry and configured to: search layers from different models and determine whether to perform layer fusing; fuse instructions in the layers from different models into a fused instruction in response to determining to perform layer fusing; combine input data for the instructions in the layers from different models into a combined input data; allocate a continuous storage area in a memory for the combined input data; load the combined input data for the fused instruction from the continuous storage area in the memory to perform the fused instruction; and store output data obtained after performing the fused instruction into a continuous storage area in the memory.
Example 2 includes the layer fusing apparatus of Example 1, wherein the processor circuitry is further configured to determine whether to perform layer fusing based on a first fusing metric.
Example 3 includes the layer fusing apparatus of Example 2, wherein the first fusing metric is a degree of saturation indicating instruction utilization in a layer that characterizes a ratio of the portion of a register actually utilized by the instruction to the whole register allocated for the instruction.
Example 4 includes the layer fusing apparatus of Example 3, wherein the processor circuitry is further configured to determine whether to perform layer fusing based on the comparison of the degree of saturation in a layer with a predetermined threshold for the degree of saturation.
Example 5 includes the layer fusing apparatus of Example 4, wherein the processor circuitry is further configured to filter out a layer if the degree of saturation in the layer is higher than the predetermined threshold for the degree of saturation.
Example 6 includes the layer fusing apparatus of Example 5, wherein the processor circuitry is further configured to determine whether to perform layer fusing based on a second fusing metric.
Example 7 includes the layer fusing apparatus of Example 6, wherein the second fusing metric is an impact factor calculated for layers from different models, the impact factor indicating whether performing layer fusing will add sync points overhead that would cause performance hits.
Example 8 includes the layer fusing apparatus of Example 7, wherein the impact factor is calculated by the following equation:

$${φ}_{i , j} = \frac{min ( {\sum }_{a = 1}^{i} {t}_{{m}_{a}} , {\sum }_{b = 1}^{j} {t}_{{n}_{b}} )}{max ( {\sum }_{a = 1}^{i} {t}_{{m}_{a}} , {\sum }_{b = 1}^{j} {t}_{{n}_{b}} )}$$

wherein φ_{i,j} is the impact factor, Σₐ₌₁ⁱ tₘ_{ₐ} represents cumulative layer execution time for layers from the first layer to i-th layer in m-th model, wherein i is not less than 1 and not greater than the number of the layers of m-th model; and Σ_{b=1}^{j} tₙ_{_{b}} represents cumulative layer execution time for layers from the first layer to j-th layer in n-th model, wherein j is not less than 1 and not greater than the number of the layers of n-th model.
Example 9 includes the layer fusing apparatus of Example 8, wherein the processor circuitry is further configured to determine whether to perform layer fusing based on the comparison of the calculated impact factor for layers with a predetermined threshold for the impact factor.
Example 10 includes the layer fusing apparatus of Example 9, wherein the processor circuitry is further configured to determine to perform layer fusing if the calculated impact factor for layers is higher than the predetermined threshold for the impact factor.
Example 11 includes the layer fusing apparatus of Example 10, wherein the processor circuitry is further configured to determine whether to perform layer fusing based on a third fusing metric.
Example 12 includes the layer fusing apparatus of Example 11, wherein the third metric is a score calculated for layers from different models, the score indicating the benefit it may get after performing layer fusing.
Example 13 includes the layer fusing apparatus of Example 12, wherein the score is calculated by the following equation:

$${Score}_{{m}_{i} {n}_{j}} = {w}_{m} * {w}_{n} * {w}_{{m}_{i}} * {w}_{{n}_{j}} * {φ}_{i , j} * ( 1 - {σ}_{{m}_{i}} ) * ( 1 - {σ}_{{n}_{j}} )$$

$${w}_{m} = \frac{{\sum }_{a = 1}^{number of layers of m - th model} {t}_{{m}_{a}}}{{\sum }_{k = 1}^{n u mber of models} {\sum }_{i = 1}^{n umber of layers of k - th model} {t}_{{k}_{i}}}$$

$${w}_{n} = \frac{{\sum }_{b = 1}^{number of layers of n - th model} {t}_{{n}_{b}}}{{\sum }_{k = 1}^{n u mber of models} {\sum }_{i = 1}^{number of layers of k - th model} {t}_{{k}_{i}}}$$

$${w}_{{m}_{i}} = \frac{{t}_{{m}_{i}}}{{\sum }_{a = 1}^{number of layers of m - th model} {t}_{{m}_{a}}}$$

$${w}_{{n}_{j}} = \frac{{t}_{{n}_{j}}}{{\sum }_{b = 1}^{n umber of layers of n - th model} {t}_{{n}_{b}}}$$

wherein σₘ_{ᵢ} is the degree of saturation of i-th layer in m-th model; σₙ_{ⱼ} is the degree of saturation of j-th layer in n-th model; wₘ is a weight of m-th model's execution time in total models' execution time; wₙ is a weight of n-th model's execution time in total models' execution time; wₘ_{ᵢ} is a weight of i-th layer's execution time in m-th model's execution time; wₙ_{ⱼ} is a weight of j-th layer's execution time in n-th model's execution time; tₘ_{ᵢ} is i-th layer's execution time in m-th model, wherein i is not less than 1 and not greater than the number of the layers of m-th model; tₙ_{ⱼ} is j-th layer's execution time in n-th model, wherein j is not less than 1 and not greater than the number of the layers of the n-th model; and φ_{i,j} is the impact factor for fusing i-th layer in m-th model with j-th layer in n-th model.
Example 14 includes the layer fusing apparatus of Example 13, wherein the processor circuitry is further configured to determine whether to perform layer fusing based on the comparison of the calculated score for layers with a predetermined threshold for the score.
Example 15 includes the layer fusing apparatus of Example 14, wherein the processor circuitry is further configured to determine to perform layer fusing if the calculated score for layers is higher than the predetermined threshold for the score.
Example 16 includes the layer fusing apparatus of Example 15, wherein the processor circuitry is further configured to perform an offline operation to search layers from different models.
Example 17 includes the layer fusing apparatus of Example 1, wherein the processor circuitry is further configured to allocate a continuous buffer pool as a shared storage area in the memory for the fused instructions.
Example 18 includes the layer fusing apparatus of Example 17, wherein the processor circuitry is further configured to provide an interface for loading the combined input data for the fused instruction and storing the output data obtained after performing operation of the fused instruction.
Example 19 includes the layer fusing apparatus of Example 1, wherein the instructions in the layers from different models comprise Single Instruction Multiple Data (SIMD) instructions that includes Vector Neural Network Instruction (VNNI), Tile matrix multiply unit (TMUL) and Advanced Matrix Extension (AMX).
Example 20 includes the layer fusing apparatus of Example 1, wherein the models are AI models.
Example 21 includes a method for fusing layers of different models, comprising: searching layers from different models and determining whether to perform layer fusing; fusing instructions in the layers from different models into a fused instruction in response to determining to perform layer fusing; combining input data for the instructions in the layers from different models into a combined input data; allocating a continuous storage area in a memory for the combined input data; loading the combined input data for the fused instruction from the continuous storage area in the memory to perform the fused instruction; and storing output data obtained after performing the fused instruction into a continuous storage area in the memory.
Example 22 includes the method of Example 21, wherein the method further comprises determining whether to perform layer fusing based on a first fusing metric.
Example 23 includes the method of Example 22, wherein the first fusing metric is a degree of saturation indicating instruction utilization in a layer that characterizes a ratio of the portion of a register actually utilized by the instruction to the whole register allocated for the instruction.
Example 24 includes the method of Example 23, wherein the method further comprises determining whether to perform layer fusing based on the comparison of the degree of saturation in a layer with a predetermined threshold for the degree of saturation.
Example 25 includes the method of Example 24, wherein the method further comprises filtering out a layer if the degree of saturation in the layer is higher than the predetermined threshold for the degree of saturation.
Example 26 includes the method of Example 25, wherein the method further comprises determining whether to perform layer fusing based on a second fusing metric.
Example 27 includes the method of Example 26, wherein the second fusing metric is an impact factor calculated for layers from different models, the impact factor indicating whether performing layer fusing will add sync points overhead that would cause performance hits.
Example 28 includes the method of Example 27, wherein the impact factor is calculated by the following equation:

$${φ}_{i , j} = \frac{min ( {\sum }_{a = 1}^{i} {t}_{{m}_{a}} , {\sum }_{b = 0}^{j} {t}_{{n}_{b}} )}{max ( {\sum }_{a = 1}^{i} {t}_{{m}_{a}} , {\sum }_{b = 1}^{j} {t}_{{n}_{b}} )}$$

wherein φ_{i,j} is the impact factor, Σₐ₌₁^{i t}ₘ_{ₐ} represents cumulative layer execution time for layers from the first layer to i-th layer in m-th model, wherein i is not less than 1 and not greater than the number of the layers of m-th model; and Σ_{b=1}^{j} tₙ_{_{b}} represents cumulative layer execution time for layers from the first layer to j-th layer in n-th model, wherein j is not less than 1 and not greater than the number of the layers of n-th model.
Example 29 includes the method of Example 28, wherein the method further comprises determining whether to perform layer fusing based on the comparison of the calculated impact factor for layers with a predetermined threshold for the impact factor.
Example 30 includes the method of Example 29, wherein the method further comprises determining to perform layer fusing if the calculated impact factor for layers is higher than the predetermined threshold for the impact factor.
Example 31 includes the method of Example 30, wherein the method further comprises determining whether to perform layer fusing based on a third fusing metric.
Example 32 includes the method of Example 31, wherein the third metric is a score calculated for layers from different models, the score indicating the benefit it may get after performing layer fusing.
Example 33 includes the method of Example 32, wherein the score is calculated by the following equation:

$${Score}_{{m}_{i} {n}_{j}} = {w}_{m} * {w}_{n} * {w}_{{m}_{i}} * {w}_{{n}_{j}} * {φ}_{i , j} * ( 1 - {σ}_{{m}_{i}} ) * ( 1 - {σ}_{{n}_{j}} )$$

$${w}_{m} = \frac{{\sum }_{a = 1}^{n umber of layers of m - th model} {t}_{{m}_{a}}}{{\sum }_{k = 1}^{n u mber of models} {\sum }_{i = 1}^{n umber of layers of k - th model} {t}_{{k}_{i}}}$$

$${w}_{n} = \frac{{\sum }_{b = 1}^{number of layers of n - th model} {t}_{{n}_{b}}}{{\sum }_{k = 1}^{n u mber of models} {\sum }_{i = 1}^{n umber of layers of k - th model} {t}_{{k}_{i}}}$$

$${w}_{{m}_{i}} = \frac{{t}_{{m}_{i}}}{{\sum }_{a = 1}^{n umber of layers of m - th model} {t}_{{m}_{a}}}$$

$${w}_{{n}_{j}} = \frac{{t}_{{n}_{j}}}{{\sum }_{b = 1}^{n umber of layers of n - th model} {t}_{{n}_{b}}}$$

wherein σₘ_{ᵢ} is the degree of saturation of i-th layer in m-th model; σₙ_{ⱼ} is the degree of saturation of j-th layer in n-th model; wₘ is a weight of m-th model's execution time in total models' execution time; wₙ is a weight of n-th model's execution time in total models' execution time; wₘ_{ᵢ} is a weight of i-th layer's execution time in m-th model's execution time; wₙ_{ⱼ} is a weight of j-th layer's execution time in n-th model's execution time; tₘ_{ᵢ} is i-th layer's execution time in m-th model, wherein i is not less than 1 and not greater than the number of the layers of m-th model; tₙ_{ⱼ} is j-th layer's execution time in n-th model, wherein j is not less than 1 and not greater than the number of the layers of the n-th model; and φ_{i,j} is an impact factor for i-th layer in m-th model and j-th layer in n-th model.
Example 34 includes the method of Example 33, wherein the method further comprises determining whether to perform layer fusing based on the comparison of the calculated score for layers with a predetermined threshold for the score.
Example 35 includes the method of Example 34, wherein the method further comprises determining to perform layer fusing if the calculated score for layers is higher than the predetermined threshold for the score.
Example 36 includes the method of Example 21, wherein searching layers from different models can be performed by an offline operation.
Example 37 includes the method of Example 21, wherein the method further comprises allocating a continuous buffer pool as a shared storage area in the memory for the fused instructions.
Example 38 includes the method of Example 37, wherein the method further comprises providing an interface for loading the combined input data for the fused instruction and storing the output data obtained after performing operation of the fused instruction.
Example 39 includes the method of Example 21, wherein the instructions in the layers from different models comprise Single Instruction Multiple Data (SIMD) instructions that includes Vector Neural Network Instruction (VNNI), Tile matrix multiply unit (TMUL) and Advanced Matrix Extension (AMX).
Example 40 includes the method of Example 21, wherein the models are AI models.
Example 41 includes a computer-readable storage medium with program instructions stored thereon which, when executed by a processor, cause the processor to implement the method of any of Examples 21-40.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1-20. (canceled)

21. A layer fusing apparatus, comprising interface circuitry; processor circuitry coupled to the interface circuitry and configured to:
search layers from different models and determine whether to perform layer fusing;
fuse instructions in the layers from different models into a fused instruction in response to determining to perform layer fusing;
combine input data for the instructions in the layers from different models into a combined input data;
allocate a continuous storage area in a memory for the combined input data;
load the combined input data for the fused instruction from the continuous storage area in the memory to perform the fused instruction; and
store output data obtained after performing the fused instruction into a continuous storage area in the memory.

22. The layer fusing apparatus of claim 21, wherein the processor circuitry is further configured to determine whether to perform layer fusing based on a first fusing metric.

23. The layer fusing apparatus of claim 22, wherein the first fusing metric is a degree of saturation indicating instruction utilization in a layer that characterizes a ratio of the portion of a register actually utilized by the instruction to the whole register allocated for the instruction.

24. The layer fusing apparatus of claim 22, wherein the processor circuitry is further configured to determine whether to perform layer fusing based on a second fusing metric.

25. The layer fusing apparatus claim 24, wherein the second fusing metric is an impact factor calculated for layers from different models, the impact factor indicating whether performing layer fusing will add sync points overhead that would cause performance hits.

26. The layer fusing apparatus claim 24, wherein the processor circuitry is further configured to determine whether to perform layer fusing based on a third fusing metric.

27. The layer fusing apparatus claim 26, wherein the third metric is a score calculated for layers from different models, the score indicating the benefit it may get after performing layer fusing.

28. The layer fusing apparatus of claim 21, wherein the processor circuitry is further configured to allocate a continuous buffer pool as a shared storage area in the memory for the fused instructions.

29. The layer fusing apparatus of claim 28, wherein the processor circuitry is further configured to provide an interface for loading the combined input data for the fused instruction and storing the output data obtained after performing operation of the fused instruction.

30. The layer fusing apparatus of claim 21, wherein the instructions in the layers from different models comprise Single Instruction Multiple Data (SIMD) instructions that includes Vector Neural Network Instruction (VNNI), Tile matrix multiply unit (TMUL) and Advanced Matrix Extension (AMX).

31. A method for fusing layers of different models, comprising:
searching layers from different models and determining whether to perform layer fusing;
fusing instructions in the layers from different models into a fused instruction in response to determining to perform layer fusing;
combining input data for the instructions in the layers from different models into a combined input data;
allocating a continuous storage area in a memory for the combined input data;
loading the combined input data for the fused instruction from the continuous storage area in the memory to perform the fused instruction; and
storing output data obtained after performing the fused instruction into a continuous storage area in the memory.

32. The method of claim 31, wherein the method further comprises determining whether to perform layer fusing based on a first fusing metric.

33. The method of claim 32, wherein the first fusing metric is a degree of saturation indicating instruction utilization in a layer that characterizes a ratio of the portion of a register actually utilized by the instruction to the whole register allocated for the instruction.

34. The method of claim 32, wherein the method further comprises determining whether to perform layer fusing based on a second fusing metric.

35. The method of claim 34, wherein the second fusing metric is an impact factor calculated for layers from different models, the impact factor indicating whether performing layer fusing will add sync points overhead that would cause performance hits.

36. The method of claim 34, wherein the method further comprises determining whether to perform layer fusing based on a third fusing metric.

37. The method of claim 36, wherein the third metric is a score calculated for layers from different models, the score indicating the benefit it may get after performing layer fusing.

38. The method of claim 31, wherein the method further comprises allocating a continuous buffer pool as a shared storage area in the memory for the fused instructions.

39. The method of claim 31, wherein the method further comprises providing an interface for loading the combined input data for the fused instruction and storing the output data obtained after performing operation of the fused instruction.

40. A computer-readable storage medium with program instructions stored thereon which, when executed by a processor, cause the processor to implement the method of claim 31.
